(19) United States
(12) Patent Application Publication
(10) Pub. No.: US 2026/0121541 A1
(43) Pub. Date: Apr. 30, 2026

(54) STATUS REPORT OF POWER STAGE CIRCUIT FOR MULTIPHASE VOLTAGE REGULATOR

(71) Applicant: Monolithic Power Systems, Inc., Kirkland, WA (US)

(72) Inventors: Wei-Chung Chen, Zhubei City (TW); Le Kong, San Jose, CA (US); Cong Deng, San Jose, CA (US); Yu-Huei Lee, New Taipei City (TW)

(21) Appl. No.: 18/926,222

(22) Filed: Oct. 24, 2024

(51) Int. Cl. H02M 3/158

(52) U.S. Cl. CPC H02M 3/1586

(57) ABSTRACT

A control circuit for a multiphase voltage regulator includes a switching control circuit, and a monitor circuit. The switching control circuit is configured to provide a plurality of control signals to control a plurality of power stage circuits. Each of the power stage circuit is configured to provide a phase current. The monitor circuit is configured to receive at least one report signal from at least one of the power stage circuits, and determine whether the report signal indicates an activated phase. After the report signal indicating the activated phase is received, the control signal is provided to the power stage circuit determined as the activated phase.

### TECHNICAL FIELD

The present disclosure relates generally to power circuits, and more particularly but not exclusively to multiphase voltage regulators.

### BACKGROUND OF THE INVENTION

Multiphase voltage regulator has been widely used in high power applications. The multiphase voltage regulator includes multiple (e.g., n) power stage circuits, where n is a positive integer greater than 1. Specifically, the n power stage circuits are coupled in parallel, and each of the power stage circuit to provide a higher output current to the load. Each power stage circuits is configured to share the input voltage and the output voltage and provide a phase current to a load. In one embodiment, the n power stage circuits are interleaved in n phases to reduce current ripple at the input and output and improve efficiency. Typically, each of the n power stage circuits is an integrated circuit (IC), and a multiphase controller is also an IC configured to provide the n phase control signals to respectively control the n power stage ICs. Therefore, it is important for the multiphase controller IC to monitor the status of the power stage ICs to provide the regulated output voltage. As a result, it is desirable to provide the status report of power stage IC.

### SUMMARY OF THE INVENTION

According to an embodiment of the present disclosure, a control circuit for a multiphase voltage regulator is provided. The control circuit includes a switching control circuit, and a monitor circuit. The switching control circuit is configured to provide a plurality of control signals to control a plurality of power stage circuits. Each of the power stage circuit is configured to provide a phase current. The monitor circuit is configured to receive at least one report signal from at least one of the power stage circuits, and determine whether the report signal indicates an activated phase. After the report signal indicating the activated phase is received, the control signal is provided to the power stage circuit determined as the activated phase.

According to yet another embodiment of the present disclosure, a control circuit for a multiphase voltage regulator is provided. The control circuit includes a switching control circuit, a plurality of switching control pins, and a monitor circuit. The switching control circuit is configured to provide a plurality of control signals. Each of the switching control circuit is configured to be coupled to a plurality of power stage circuits. Each of the power stage circuit is configured to provide a phase current. The monitor circuit is configured to receive a plurality of voltage signals of the switching control pins, determine whether the voltage signal of the switching control pin indicates an activated phase, and obtain a phase number of the power stage circuits according to the voltage signals of the switching control pins.

According to yet another embodiment of the present disclosure, a multiphase voltage regulator is provided. The multiphase voltage regulator includes a plurality of power stage circuits, and a control circuit. Each of the power stage circuit is configured to provide a phase current. Each power stage circuit includes at least one power switch and a report pin. The report pin is configured to provide a report signal. The control circuit is coupled to the power stage circuits. The control circuit is configured to receive at least one report signal from at least one of the power stage circuits, determine whether the report signal indicates an activated phase; and provide a control signal to the corresponding power stage circuit determined as the activated phase.

According to yet another embodiment of the present disclosure, a method for controlling a multiphase voltage regulator is provided. The method includes the following actions. A plurality of report signal is received from a plurality of switching control pins coupled to a plurality of power stage circuits. Whether a first report signal received from a first power stage circuit is greater than a voltage threshold is determined. When the first report signal is greater than the voltage threshold, the first power stage circuit is determined as ready. After the first report signal is greater than the voltage threshold, whether each of the report signals is greater than the voltage threshold is determined. The corresponding power stage circuit is determined as an activated phase when the report signal is greater than the voltage threshold.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 is a schematic block diagram of a multiphase voltage regulator in accordance with an embodiment of the present disclosure.

FIG. 2 is a schematic block diagram of a multiphase controller IC in accordance with an embodiment of the present disclosure.

FIG. 3 is a schematic block diagram of a power stage IC in accordance with an embodiment of the present disclosure.

FIG. 4 is a schematic circuit diagram of a multiphase voltage regulator in accordance with one embodiment of the present disclosure.

FIG. 5 is a flowchart of a method for controlling a multiphase voltage regulator in accordance with one embodiment of the present disclosure.

FIG. 6 is a flowchart of a method for controlling a multiphase voltage regulator in accordance with another embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

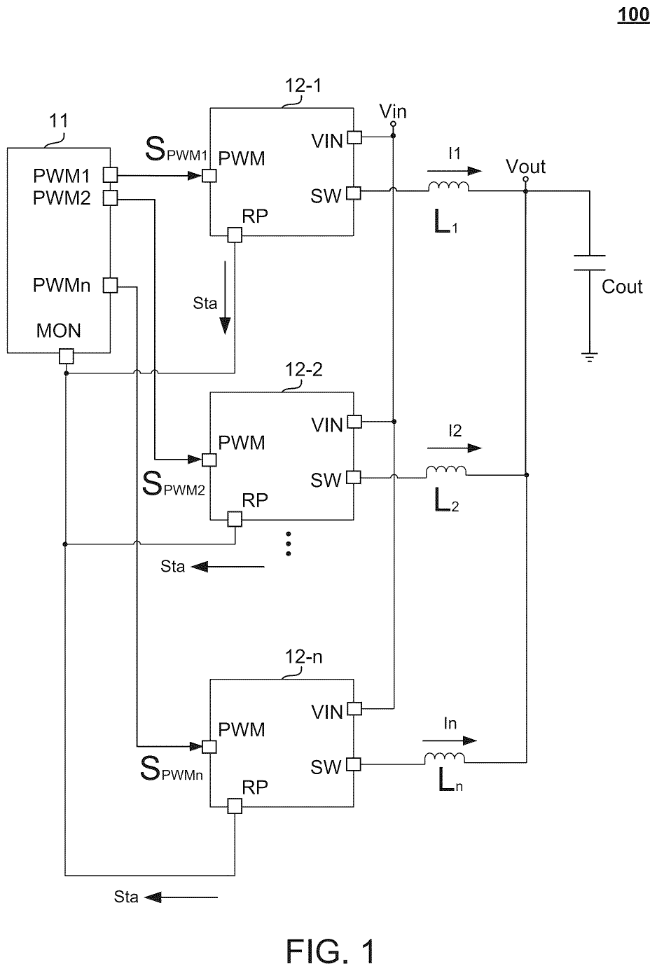

FIG. 1 is a schematic block diagram of a multiphase voltage regulator 100 in accordance with an embodiment of the present disclosure. The multiphase voltage regulator 100 includes a control circuit 11 and multiple (e.g., n) power stage circuits 12-1 to 12-n, where n is a positive integer greater than 1. The n power stage circuits are coupled in parallel, and each of the power stage circuit to provide a phase current to the load. Each power stage circuits is configured to share the input voltage Vin and the output voltage Vout and provide a phase current (e.g., I1, I2, . . . , In) to a load. In one embodiment, the n power stage circuits are interleaved in n phases to reduce current ripple at the input and output and improve efficiency. The control circuit 11 is configured to provide the n phase control signals (e.g., S_{PWM1}, S_{PWM2}, . . . , S_{PWMn}) to respectively control the n power stage circuits.

In one implementation, the multiphase voltage regulator 100 is a multiphase buck converter. However, the present disclosure is not limited thereto. The multiphase voltage regulator 100 may be a multiphase boost converter, a trans-inductor voltage regulator (TLVR), a multiphase DC-DC converters, or any multiphase converters. In some implementations, the multiphase voltage regulator 100 is an isolated converter. In some other implementations, the multiphase voltage regulator 100 is a non-isolated converter.

In one embodiment, the control circuit 11 is a multiphase controller integrated circuit (IC) having n switching control pins (e.g., PWM1-PWMn) and a monitor pin (e.g., MON). In one embodiment, each of the power stage circuits 12-1 to 12-n is an IC. Each of the power stage circuits 12-1 to 12-n includes a VIN pin configured to receive the input voltage Vin, a SW pin configured to provide the output voltage Vout via the inductor (e.g., L₁, L₂, . . . , Lₙ), a switching control pin (e.g., PWM) configured to receive the control signals (e.g., S_{PWM1}, S_{PWM2}, . . . , S_{PWMn}) from the multiphase controller IC 11, and a report pin (e.g., RP) configured to transmit a report signal (e.g., Sta) to the multiphase controller IC 11. The report signal indicates whether the phase is activated.

For example, the multiphase controller IC 11 has n switching control pins (e.g., PWM1-PWMn). That is, the multiphase controller IC 11 supports n-phase operation. However, in practical applications, only k<n phases are used. In other words, only k switching control pins are connected to provide the k phase control signal to the corresponding k power stage IC, while other (n-k) pins are not connected to the power stage IC. For instance, the switching control pins of the deactivated phase are floating or connected to ground. The multiphase controller IC 11 needs to know the phase number of the power stage circuits. The multiphase controller IC 11 performs phase configuration according to the phase number. For example, there are 6 phases, and therefore the multiphase controller IC 11 provides the control signals (e.g., S_{PWM1}-S_{PWM6}) to the activated phase via the switching control pins PWM1-PWM6.

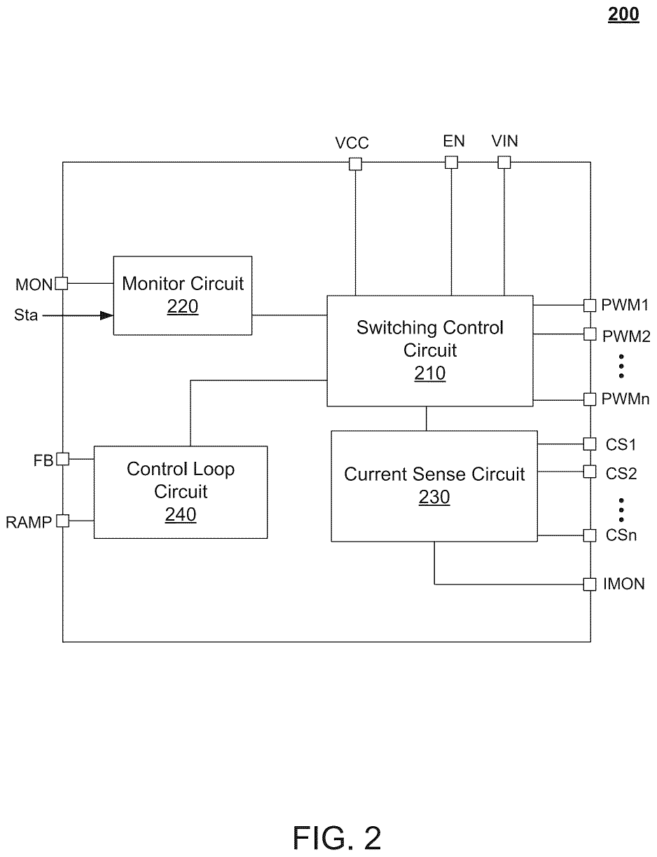

FIG. 2 is a schematic block diagram of a multiphase controller IC 200 in accordance with an embodiment of the present disclosure. The multiphase controller IC 200 includes a switching control circuit 210, and a monitor circuit 220. The switching control circuit 210 is configured to provide control signals via the switching control pins (e.g., PWM1, PWM2, . . . , PWMn) to control the power stage circuits. The monitor circuit 220 is configured to receive a report signal (e.g., Sta) via the monitor pin (e.g., MON), and determine whether the report signal Sta indicates the corresponding power stage circuit is activated. In one embodiment, the monitor pin MON is configured to receive the status of one of the power stage circuits, and the report signal Sta is received via the monitor pin MON. For example, the status of the power stage circuit indicates an event or a warning. In one implementation, different voltage levels of the monitor pin MON are configured to indicate different events or warnings, and whether the corresponding power stage circuit is activated. In some implementations, the report signal Sta is a digital signal configured to represent various fault types, warning and whether the corresponding power stage circuit is activated. Accordingly, the monitor circuit 220 is configured to receive a report signal Sta via the monitor pin MON, and determine whether the report signal Sta indicates the corresponding power stage circuit is activated. In one embodiment, the monitor circuit 220 includes a comparator configured to compare the report signal Sta with a voltage threshold. When the report signal Sta is greater than the voltage threshold, the monitor circuit 220 is configured to determine that the corresponding power stage circuit is activated.

In one embodiment, the multiphase controller IC 300 further includes a current sense circuit 230 configured to receive current sense signals indicating the respective phase currents of the power stage circuits via the current sense pin (e.g., CS1, CS2, . . . , CSn). In one embodiment, the current sense signals are used to provide a total load current sense signal via the pin IMON.

In one embodiment, the multiphase controller IC 200 further includes a control loop circuit 240 configured to regulate the output voltage Vout. For example, the control loop circuit 240 senses the feedback voltage via the feedback pin FB. The feedback voltage represents the output voltage Vout. In one embodiment, the feedback voltage is compared with a reference signal to generate a compensation signal (e.g., via an error amplifier EA), and the compensation signal is compared with a ramp signal received via the pin RAMP to generate a control signal (e.g., via a PWM comparator). In another embodiment, the feedback voltage is compared with a reference signal to generate a compensation signal (e.g., via an error amplifier EA), and the compensation signal is compared with the inductor current to generate the control signal (e.g., via a PWM comparator). In yet another embodiment, the feedback voltage is compared with a reference signal to generate a compensation signal (e.g., via a PWM comparator), and the control signal is generated in response to the compensation signal and an on-time.

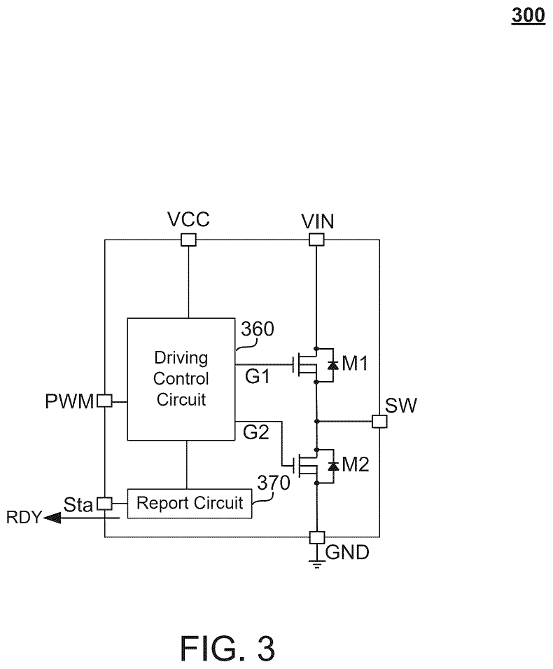

FIG. 3 is a schematic block diagram of a power stage IC 300 in accordance with an embodiment of the present disclosure. The power stage IC 300 includes two power switches M1 and M2, a driving control circuit 360, and a report circuit 370. In one implementation, the power switches M1 and M2 are n-type Metal-Oxide-Semiconductor Field-Effect Transistor (MOSFETs). The first terminal (e.g., drain) of the power switch M1 is coupled to the VIN pin configured to receive the input voltage, the second terminal (e.g., source) of the power switch M1 is coupled to the SW pin and the first terminal (e.g., drain) of the power switch M2. The second terminal (e.g., source) of the power switch M2 is coupled to the GND pin configured to be coupled to a reference voltage level (e.g., the ground). The control terminal (e.g., gate) of the power switch M1 and the control terminal (e.g., gate) of the power switch M2 are coupled to the driving control circuit 360. The driving control circuit 360 is configured to receive a control signal from the switching control pin PWM and provide the driving signals G1 and G2 to the gate terminals of the power switches M1 and M2, respectively. Specifically, the power switches M1 and M2 are turned on and turned off in response to the driving signals G1 and G2, respectively, and provide a switching signal at the SW pin. The report circuit 370 is configured to provide a report signal Sta indicating the corresponding power stage circuit is activated via the report pin RP. In one embodiment, the driving control circuit 360 and the report circuit 370 is coupled to a supply voltage (e.g., Vcc), and the report circuit 370 is further configured to generate the report signal Sta in response to the supply voltage (e.g., Vcc).

In one embodiment, the power stage IC 300 further includes an under voltage lockout (UVLO) circuit (not shown) configured to disable the operation of the driving control circuit 360 when the supply voltage (e.g., received via the VCC pin) is insufficient to protect the power stage IC 300.

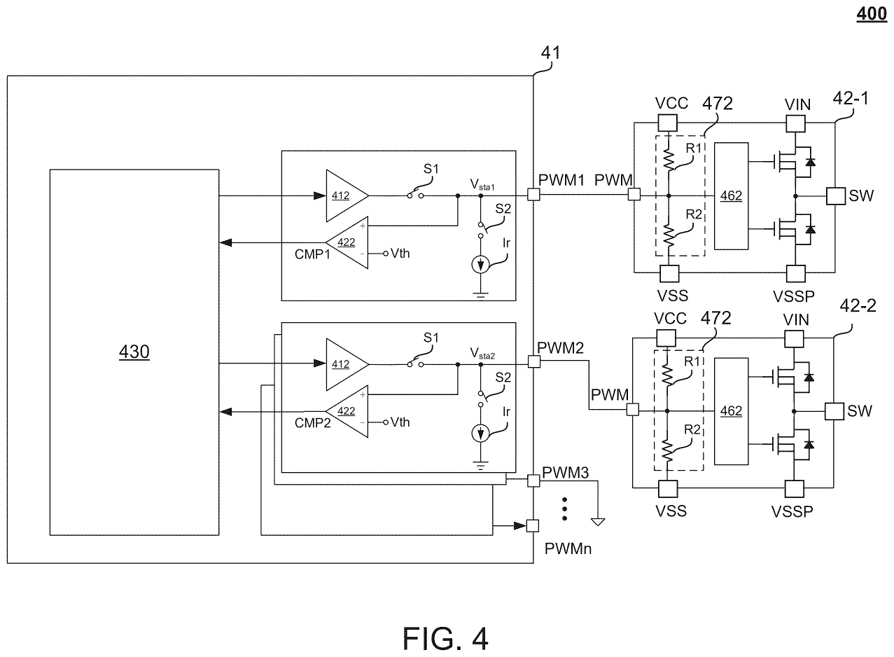

FIG. 4 is a schematic circuit diagram of a multiphase voltage regulator 400 in accordance with one embodiment of the present disclosure. In this embodiment, the report signal is realized by the voltage signal received via the switching control pin (e.g., PWMx). In another embodiment, the report signal is realized by the current signal received via the switching control pin (e.g., PWMx). For instance, during an initial period, that is before the multiphase voltage regulator 400 is powered on, the switching control circuit 412 of the multiphase controller IC 410 provides the control signal S_{PWM}x with a high impedance (Hi-Z) mode to the power stage IC 42-x, Thus, all of the switching control pins PWM1-PWMn of the multiphase controller IC 41 are in high impedance state. Specifically, the switching control pins PWM1-PWMn are coupled to the respective switching control pin PWM of the power stage ICs 42-1 to 42-n. As shown in FIG. 4, the report circuit 472 of each of the power stage IC 42-x includes a voltage divider coupled to the switching control pin PWM. For example, two resistors (e.g., resistors R1 and R2) are connected between the supply voltage terminal VCC and the ground terminal VSS. Therefore, the voltage of the switching control pin PWM of the power stage IC (e.g., 42-1) is at a middle voltage level, and thus the corresponding switching control pin (e.g., PWM1) of the multiphase controller IC 41 keeps in a tri-state logic level. For instance, the control signal (i.e., the voltage of the switching control pin PWM) has three states, a high logic level (e.g., 2-3.3V) to turn on the high-side switch M1, a low logic level (e.g., 0-1V) to turn on the low-side switch M2, and a tri-state logic level (e.g., 1-2V) to make the multiphase voltage regulator 400 in the Hi-Z mode (or inactive). In one embodiment, when the voltage signal Vsta1 matches a middle voltage level (e.g., 1-2V), it is determined that the power stage IC 42-x is an activated phase.

Specifically, for each phase, the monitor circuit of the multiphase controller IC 41 includes a voltage reference circuit coupled to the corresponding switching control pin PWMx. The voltage reference circuit is configured to connect the corresponding switching control pin PWMx to a voltage reference. In one implementation, the voltage reference circuit includes a current source Ir. In another implementation, the voltage reference circuit includes a resistor. In some implementations, the voltage reference circuit includes a transistor. During the initial period, the switch S1 is turned off, and the switch S2 is turned on, and the current source Ir is configured to pull down the voltage of the corresponding switching control pin (e.g., PWMx). In one embodiment, the monitor circuit includes a comparator 422 configured to compare the voltage signal Vₛₜₐ₁ with a voltage threshold Vth. In one implementation, when it is determined that the voltage signal Vₛₜₐ₁ is greater than a voltage threshold Vth (e.g., 1.1V), the signal CMP1 is issued, and thus the corresponding switching control pin (e.g., and the power stage IC 42-x) is determined to be an activated phase. In one implementation, the signal CMP1 with a high logic level (e.g., “1”) indicates the activated phase, while a low logic level (e.g., “0”) of the signal CMP1 indicates the deactivated phase. When the voltage signal Vₛₜₐ₁ is less than the voltage threshold Vth (e.g., 1.1V), the corresponding switching control pin is determined to be a deactivated phase.

As shown in FIG. 4, since the switching control pin PWM1 is coupled to the voltage divider of the power stage IC 42-1, the voltage signal Vₛₜₐ₁ is greater than the voltage threshold Vth (e.g., 1.1V), the power stage IC 42-1 is determined to be activated. Similarly, the voltage of the switching control pin PWM2 is also greater than the voltage threshold Vth (e.g., 1.1V), and thus it is also activated. On the other hand, since the switching control pin PWM3 is coupled to the ground, which is less than the voltage threshold Vth (e.g., 1.1V), the switching control pin PWM3 is determined to be the deactivated phase. Since the switching control pin PWMn is floating, the voltage of the switching control pin PWM is pulled down by the current source Ir, which is also less than the voltage threshold Vth (e.g., 1.1V), and the switching control pin PWMn is also determined to be the deactivated phase.

It should be noted that the configuration of FIG. 4 is only an example, and the present disclosure is not limited thereto. According to practical applications, each switching control pin PWMx may be coupled to the power stage IC, ground or floating. The multiphase controller IC 41 determines whether each of the witching control pin PWMx is activated or deactivated. In one example, according to the voltage of the switching control pin, the multiphase controller IC 41 identifies that the switching control pins PWM1, PWM3 PWM5 are the activated phase.

In one embodiment, the voltage reference is the ground, and the current source Ir is configured to pull down the voltage of the switching control pin. However, in another embodiment, the current source Ir is configured to pull up the voltage of the switching control pin to the supply voltage (e.g., Vcc). Accordingly, the comparator 422 determines that the voltage signal Vsta1 is greater than the voltage threshold Vth (e.g., 2.5V), the switching control pin PWM1 is determined to be the deactivated phase. In this implementation, the signal CMP1 with a high logic level (e.g., “1”) indicates the deactivated phase, while a low logic level (e.g., “0”) of the signal CMP1 indicates the activated phase.

In another embodiment, instead of the comparator, the monitor circuit detects whether the voltage signal Vₛₜₐ₁ of the switching control pin changes. When the voltage signal of the switching control pin changes, the control circuit 530 determines that the corresponding switching control pin is deactivated. For instance, in the embodiment that the corresponding switching control pin is connected to the ground, a falling edge of the voltage signal Vₛₜₐ₁ indicates the deactivated phase. In another embodiment that the corresponding switching control pin is connected to the supply voltage Vcc, a rising edge of the voltage signal Vₛₜₐ₁ indicates the deactivated phase.

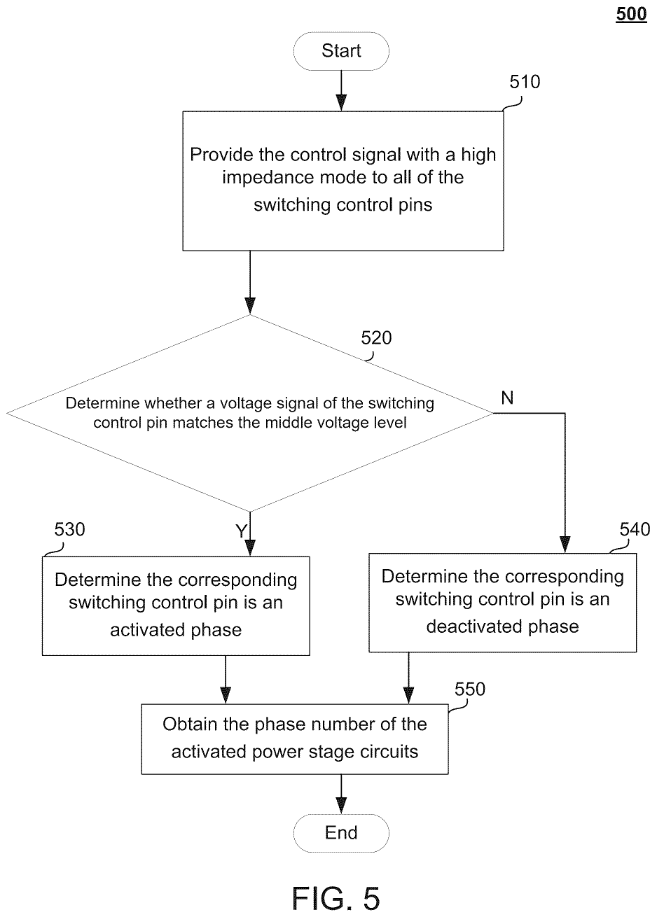

FIG. 5 is a flowchart of a method 500 for controlling a multiphase voltage regulator in accordance with one embodiment of the present disclosure. The method 500 may be performed by a multiphase controller IC 11, 200, 410 as shown in FIGS. 1-2, and 4. The method includes the following actions. When the supply voltage is sufficient, the phase configuration detect is performed. In action 510, the control signal with a high impedance (Hi-Z) mode is provided to all of the switching control pins. In action 520, whether a voltage signal of the switching control pin matches the middle voltage level is determined. When the voltage signal of the switching control pin matches the middle voltage level, action 530 is performed. In action 530, the corresponding switching control pin is determined as an activated phase. When the voltage signal of the switching control pin do not match the middle voltage level, action 540 is performed. In action 540, the corresponding switching control pin is determined as a deactivated phase. In action 550, the phase number of the activated power stage circuits is obtained. Although the flowchart of FIG. 5 shows a sequential action. It is obvious to persons skilled the art that these actions could be performed in any order.

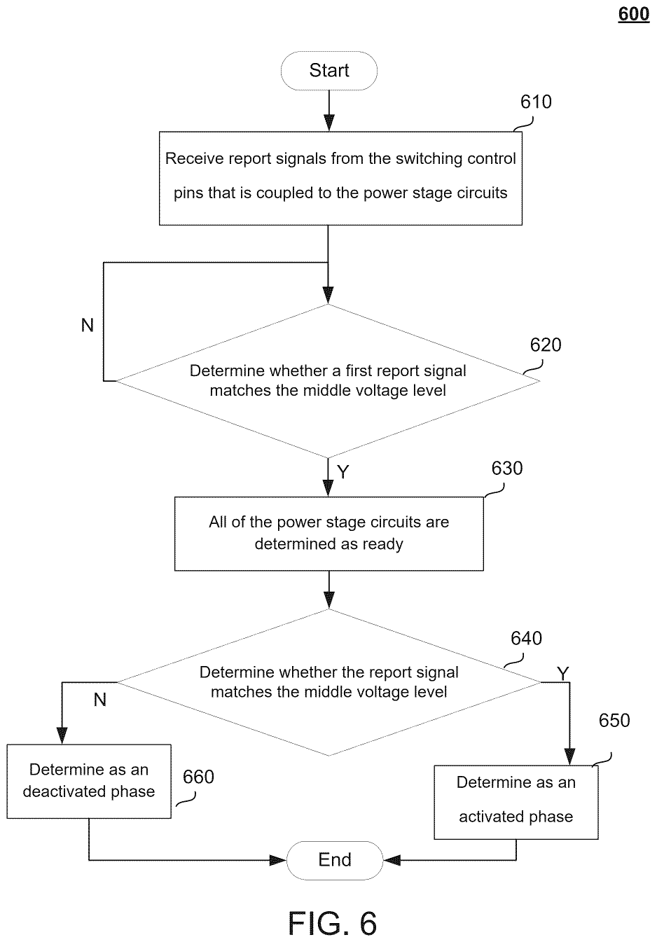

In some implementations, when the supply voltage (e.g., received via the VCC pin) is insufficient during start-up, the voltage signal Vₛₜₐ₁ is lower than a threshold. For example, when the supply voltage is 0, the voltage signal Vₛₜₐ₁ is also 0. Therefore, if the voltage signal Vₛₜₐ₁ is less than the reference voltage Vth (e.g., 1.1V), the power stage circuit is determined falsely as the deactivated phase due to insufficient supply voltage. FIG. 6 is a flowchart of a method 600 for controlling a multiphase voltage regulator in accordance with another embodiment of the present disclosure. In this embodiment, whether the power stage is ready is determined by detecting whether the supply voltage is sufficient. In action 610, a plurality of report signal is received from the switching control pins that is coupled to the power stage circuits. In action 620, whether a first report signal received from a first power stage circuit matches the middle voltage level is determined. When the first report signal matches the middle voltage level, in action 630, the first power stage circuit is determined as ready. The phase configuration detect is performed after the first report signal matches the middle voltage level, that is, when the supply voltage is sufficient. In action 640, whether each of the report signals matches the middle voltage level is determined. The corresponding power stage circuit is determined as an activated phase when the report signal matches the middle voltage level as shown in action 650. The corresponding power stage circuit is determined as a deactivated phase when the report signal do not match the middle voltage level as shown in action 660.

On the other hand, after action 620 is performed, when the first report signal is not greater than the voltage threshold (e.g., 1.1V), the first power stage circuit may be not ready due to insufficient supply voltage. Therefore, action 620 is performed after a period of time, for example, until the supply voltage is charged to the target value (e.g., 3.3V) during start-up. After the first report signal is greater than the voltage threshold (e.g., 1.1V), it means that the supply voltage is charged up and the first power stage circuit is ready and it is also determined as an activated phase. Moreover, since the supply voltage of the first power stage circuit is ready, the supply voltage of the other power stage circuits should be ready. As a result, there is no need to check whether all the other power stage circuits is ready. That is, the above method may perform the phase configuration detect and determine whether the power stage circuit is ready to be powered-on by detecting the voltage of each of the switching control pins with the same voltage threshold. In one embodiment, the voltage threshold for each of the power stage circuits is set according to their UVLO conditions. Although the flowchart of FIG. 6 shows a sequential action. It is obvious to persons skilled the art that these actions could be performed in any order.

It should be understood that, the control circuit and the related components, circuit structures, signals, and waveforms described or shown above in the present disclosure are only for illustration purpose. However, the present disclosure is not limited thereto. Persons having ordinary skill in the art may understood that the control circuit of the present disclosure could be realized, according to practical applications, by any other circuits with different circuit structures, and thus controlled by different types of the corresponding signals to achieve the corresponding functions. For example, the compensation circuit, the ramp generation circuit, the comparison circuit and the logic circuit could be realized by a digital circuit, an analog circuit, a software, an automatic generation circuit by hardware description language, or a combination of the above.

It will be appreciated by persons skilled in the art that the present disclosure is not limited to what has been particularly shown and described herein above. Rather the scope of the present disclosure is defined by the claims and includes both combinations and sub-combinations of the various features described hereinabove as well as variations and modifications thereof which would occur to persons skilled in the art upon reading the foregoing description and which are not in the prior art.

What is claimed is:

1. A control circuit for a multiphase voltage regulator, comprising:
a switching control circuit configured to provide a plurality of control signals to control a plurality of power stage circuits, wherein each of the power stage circuit is configured to provide a phase current; and
a monitor circuit configured to receive at least one report signal from at least one of the power stage circuits, and determine whether the report signal indicates an activated phase;
wherein after the report signal indicating the activated phase is received, the control signal is provided to the power stage circuit determined as the activated phase.

2. The control circuit of claim 1, wherein the control circuit is an integrated circuit, further comprising:
a plurality of switching control pins, each of which is configured to provide the control signal to the power stage circuit;
wherein the switching control circuit is configured to provide the control signal with a high impedance mode to all of the switching control pins during an initial period;
wherein a plurality of the report signals are received via the switching control pins;
wherein the monitor circuit is further configured to compare each of the report signal with a middle voltage level; and
wherein the monitor circuit is configured to determine that the corresponding power stage circuit is the activated phase when the report signal matches the middle voltage level.

3. The control circuit of claim 2, wherein when the report signal is less than a voltage threshold, the corresponding switching control pin is determined to be a deactivated phase.

4. The control circuit of claim 2, wherein when the report signal is greater than a voltage threshold, the corresponding switching control pin is determined to be the activated phase.

5. The control circuit of claim 2, wherein the monitor circuit further comprises:
a plurality of voltage reference circuits coupled to the switching control pins, wherein each of the voltage reference circuits is configured to connect the corresponding switching control pin to a voltage reference;
wherein when the report signal remains at the middle voltage level, the corresponding switching control pin is determined to be the activated phase.

6. The control circuit of claim 5, wherein when the voltage of the report signal changes, the corresponding switching control pin is determined to be the deactivated phase.

7. The control circuit of claim 1, wherein the monitor circuit is configured to obtain a phase number of the power stage circuits according to the report signal indicating the activated phase.

8. A control circuit for a multiphase voltage regulator, comprising:
a switching control circuit configured to provide a plurality of control signals;
a plurality of switching control pins, each of which is configured to be coupled to a plurality of power stage circuits, wherein each of the power stage circuit is configured to provide a phase current; and
a monitor circuit configured to receive a plurality of voltage signals of the switching control pins, determine whether the voltage signal of the switching control pin indicates an activated phase, and obtain a phase number of the power stage circuits according to the voltage signals of the switching control pins.

9. The control circuit of claim 8, wherein the monitor circuit is further configured to compare each of the voltage signal of the switching control pin with a middle voltage level, and determine that the corresponding power stage circuit is the activated phase when the voltage signal of the switching control pin matches the middle voltage level.

10. The control circuit of claim 9, wherein when the voltage signal of the switching control pin is less than a voltage threshold, the corresponding switching control pin is determined to be a deactivated phase.

11. The control circuit of claim 9, wherein when the voltage signal of the switching control pin is greater than a voltage threshold, the corresponding switching control pin is determined to be the activated phase.

12. The control circuit of claim 9, wherein the monitor circuit further comprises:
a plurality of voltage reference circuits coupled to the switching control pins, wherein each of the voltage reference circuits is configured to connect the corresponding switching control pins to a voltage reference;
wherein when the voltage signal of the switching control pin remains at the middle voltage level, the corresponding switching control pin is determined to be the activated phase.

13. The control circuit of claim 12, wherein when the voltage signal of the switching control pin changes, the corresponding switching control pin is determined to be the deactivated phase.

14. The control circuit of claim 8, wherein the monitor circuit is configured to obtain a phase number of the power stage circuits according to the voltage signal of the switching control pin.

15. A multiphase voltage regulator, comprising:
a plurality of power stage circuits, each of which is configured to provide a phase current, wherein each power stage circuit comprise at least one power switch and a report pin, wherein the report pin is configured to provide a report signal; and
a control circuit coupled to the power stage circuits, wherein the control circuit is configured to:
receive at least one report signal from at least one of the power stage circuits,
determine whether the report signal indicates an activated phase; and
provide a control signal to the corresponding power stage circuit determined as the activated phase.

16. The multiphase voltage regulator of claim 15, wherein the control circuit is an integrated circuit, further comprising:
a plurality of switching control pins, each of which is configured to provide the control signal to the power stage circuit;
wherein the switching control circuit is configured to provide the control signal with a high impedance mode to all of the switching control pins during an initial period;
wherein a plurality of the report signals are received via the switching control pins;
wherein the control circuit is further configured to compare each of the report signal with a middle voltage level; and
wherein the control circuit is configured to determine that the corresponding power stage circuit is the activated phase when the report signal matches the middle voltage level.

17. The multiphase voltage regulator of claim 16, wherein the control circuit further comprises:
a plurality of voltage reference circuits coupled to the switching control pins, wherein each of the voltage reference circuits is configured to connect the corresponding switching control pin to a voltage reference;
wherein when the voltage signal of the switching control pin remains at the middle voltage level, the switching control pin is determined to be the activated phase.

18. The multiphase voltage regulator of claim 17, wherein when the voltage signal of the switching control pin changes, the switching control pin is determined to be the deactivated phase.

19. The multiphase voltage regulator of claim 15, wherein the control circuit is configured to obtain a phase number of the power stage circuits according to the report signal indicating the activated phase.

20. A method for controlling a multiphase voltage regulator, comprises:
receiving a plurality of report signal from a plurality of switching control pins coupled to a plurality of power stage circuits;
determining whether a first report signal received from a first power stage circuit is greater than a voltage threshold, wherein when the first report signal is greater than the voltage threshold, the first power stage circuit is determined as ready;
after the first report signal is greater than the voltage threshold, determine whether each of the report signals is greater than the voltage threshold, wherein the corresponding power stage circuit is determined as an activated phase when the report signal is greater than the voltage threshold; and
providing at least one control signal to the corresponding power stage circuit determined as the activated phase.
